(19) United States
(12) Patent Application Publication
(10) Pub. No.: US 2024/0284403 A1
(43) Pub. Date: Aug. 22, 2024

(54) SYSTEM AND METHOD OF MONITORING EARLY PAGING INDICATION

(71) Applicant: Samsung Electronics Co., Ltd., Gyeonggi-do (KR)

(72) Inventor: Anil AGIWAL, Gyeonggi-do (KR)

(21) Appl. No.: 18/570,343

(22) PCT Filed: Jun. 22, 2022
(86) PCT No.: PCT/KR2022/008884

§ 371 Date: Dec. 14, 2023

(30) Foreign Application Priority Data
Jun. 22, 2021 (KR) 10-2021-0080986

(51) Int. Cl. H04W 68/02

(52) U.S. Cl. CPC H04W 68/02

(57) ABSTRACT

The disclosure provides a method performed by a user equipment (UE) in a wireless communication system. The method includes receiving system information, identifying whether first information on a number of subgroups for UE identity (ID) based subgrouping is configured in the system information, and monitoring a paging early indication, wherein in case that the first information is not configured, the paging early indication is monitored based on a subgroup ID assigned by a core network (CN).

### TECHNICAL FIELD

The disclosure relates to operations of a user equipment (UE) and a base station (BS) in a wireless communication system. More particularly, the disclosure relates to method for monitoring an early paging indication.

### BACKGROUND ART

Fifth generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement sixth generation (6G) mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive Multiple-Input Multiple-Output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of Bandwidth Part (BWP), new channel coding methods such as a Low Density Parity Check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random-access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultrahigh-performance communication and computing resources.

The above information is presented as background information only to assist with an understanding of the disclosure. No determination has been made, and no assertion is made, as to whether any of the above might be applicable as prior art with regard to the disclosure.

### DISCLOSURE OF INVENTION

### Technical Problem

The disclosure relates to operations of a user equipment (UE) and a base station (BS) in a wireless communication system. More particularly, the disclosure relates to method for monitoring an early paging indication.

An aspect of the disclosure is to provide a method and apparatus for selecting a paging subgrouping method.

Another aspect of the disclosure is to provide a method and an apparatus for monitoring early paging indication.

Additional aspects will be set forth in part in the description which follows and, in part, will be apparent from the description, or may be learned by practice of the presented embodiments.

### Solution to Problem

In accordance with an aspect of the disclosure, a method performed by a user equipment (UE) in a wireless communication system is provided. The method includes receiving system information, identifying whether first information on a number of subgroups for UE identity (ID) based subgrouping is configured in the system information, and monitoring a paging early indication, wherein in case that the first information is not configured, the paging early indication is monitored based on a subgroup ID assigned by a core network (CN).

In accordance with another aspect of the disclosure, a method performed by a base station in a wireless communication system is provided. The method includes determining whether first information on a number of subgroups for UE identity (ID) based subgrouping is configured in system information, and transmitting system information, wherein in case that the first information is not configured, a paging early indication is monitored based on a subgroup ID assigned by a core network (CN).

In accordance with another aspect of the disclosure, a user equipment (UE) in a wireless communication system is provided. The UE includes a transceiver configured to transmit and receive signals, and a controller coupled with the transceiver. The controller is configured to receive, via the transceiver, system information, identify whether first information on a number of subgroups for UE identity (ID) based subgrouping is configured in the system information, and monitor a paging early indication, wherein in case that the first information is not configured, the paging early indication is monitored based on a subgroup ID assigned by a core network (CN).

In accordance with another aspect of the disclosure, a base station in a wireless communication system is provided. The base station includes a transceiver configured to transmit and receive signals, and a controller coupled with the transceiver. The controller is configured to determine whether first information on a number of subgroups for UE identity (ID) based subgrouping is configured in system information, and transmit, via the transceiver, system information, wherein in case that the first information is not configured, a paging early indication is monitored based on a subgroup ID assigned by a core network (CN).

Other aspects, advantages, and salient features of the disclosure will become apparent to those skilled in the art from the following detailed description, which, taken in conjunction with the annexed drawings, discloses various embodiments of the disclosure.

### Advantageous Effects of Invention

According to an embodiment of the disclosure, a paging subgrouping method can be selected.

According to an embodiment of the disclosure, monitoring of an early paging indication can be performed based on one of a paging subgroup identity assigned by CN or a paging sub group identity based on UE_ID.

According to an embodiment of the disclosure, the UE can monitor paging occasion based on the early paging indication.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 illustrates an example of UE operation for monitoring early paging indication according to an embodiment of the disclosure;

FIG. 2 illustrates another example of UE operation for monitoring early paging indication according to an embodiment of the disclosure;

FIG. 3A illustrates an example of a bitmap corresponding to paging subgroups according to an embodiment of the disclosure;

FIG. 3B illustrates another example of a bitmap corresponding to paging subgroups according to an embodiment of the disclosure;

FIG. 4 illustrates various ways of mapping bits to CN assigned paging sub groups and UE ID based paging sub groups according to an embodiment of the disclosure;

FIG. 5 illustrates an example of a bitmap corresponding to paging subgroups assigned by CN according to an embodiment of the disclosure;

FIG. 6 illustrates another example of a bitmap corresponding to paging subgroups assigned by CN according to an embodiment of the disclosure;

FIG. 7 illustrates an example of a bitmap corresponding to paging subgroups based on UE ID according to an embodiment of the disclosure;

FIG. 8 illustrates another example of a bitmap corresponding to paging subgroups based on UE ID according to an embodiment of the disclosure;

FIG. 9A illustrates an example of a bitmap corresponding to paging subgroups according to an embodiment of the disclosure;

FIG. 9B illustrates another example of a bitmap corresponding to paging subgroups according to an embodiment of the disclosure;

FIG. 10 illustrates an example of a bitmap corresponding to paging subgroups based on UE ID according to an embodiment of the disclosure;

FIG. 11 illustrates another example of a bitmap corresponding to paging subgroups based on UE ID according to an embodiment of the disclosure;

FIG. 12 illustrates an example of a plurality of PEI occasions with different offsets according to an embodiment of the disclosure;

FIG. 13 illustrates an example of an operation of a UE which is not in good channel condition according to an embodiment of the disclosure;

FIG. 14 illustrates an example of an operation of a UE which is in average channel condition according to an embodiment of the disclosure;

FIG. 15 illustrates an example of an operation of a UE which is in very good channel condition according to an embodiment of the disclosure;

FIG. 16 illustrates an example of a structure of a UE according to an embodiment of the disclosure; and

FIG. 17 illustrates an example of a structure of a base station according to an embodiment of the disclosure.

### MODE FOR THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Before undertaking the detailed description below, it can be advantageous to set forth definitions of certain words and phrases used herein. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, connect to, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller can be implemented in hardware or a combination of hardware and software and/or firmware. The functionality associated with any particular controller can be centralized or distributed, whether locally or remotely. The phrase “at least one of,” when used with a list of items, means that different combinations of one or more of the listed items can be used, and only one item in the list can be needed. For example, “at least one of: A, B, and C” includes any of the following combinations: A, B, C, A and B, A and C, B and C, and A and B and C. For example, “at least one of: A, B, or C” includes any of the following combinations: A, B, C, A and B, A and C, B and C, and A and B and C.

Moreover, various functions described below can be implemented or supported by one or more computer programs, each of which is formed from computer-readable program code and embodied in a computer-readable medium. The terms “application” and “program” refer to one or more computer programs, software components, sets of instructions, procedures, functions, objects, classes, instances, related data, or a portion thereof adapted for implementation in a suitable computer-readable program code. The phrase “computer-readable program code” includes any type of computer code, including source code, object code, and executable code. The phrase “computer-readable medium” includes any type of medium capable of being accessed by a computer, such as Read-Only Memory (ROM), Random Access Memory (RAM), a hard disk drive, a Compact Disc (CD), a Digital Video Disc (DVD), or any other type of memory. A “non-transitory” computer-readable medium excludes wired, wireless, optical, or other communication links that transport transitory electrical or other signals. A non-transitory computer-readable medium includes media where data can be permanently stored and media where data can be stored and later overwritten, such as a rewritable optical disc or an erasable memory device.

Terms used herein to describe the embodiments are not intended to limit and/or define the scope of the disclosure. For example, unless otherwise defined, the technical terms or scientific terms used in the disclosure shall have the ordinary meaning understood by those with ordinary skills in the art to which the disclosure belongs.

It should be understood that “first”, “second” and similar words used in the disclosure do not express any order, quantity or importance, but are only used to distinguish different components. Unless otherwise indicated by the context clearly, similar words such as “a”, “an” or “the” in a singular form do not express a limitation of quantity, but express an existence of at least one.

As used herein, any reference to “one example” or “example”, and “one embodiment” or “embodiment” means that particular elements, features, structures or characteristics described in connection with the embodiment is included in at least one embodiment. The phrases “in one embodiment” or “in one example” appearing in different places do not necessarily refer to the same embodiment.

It will be further understood that similar words such as the term “include” or “comprise” mean that elements or objects appearing before the word encompass the listed elements or objects appearing after the word and their equivalents, but other elements or objects are not excluded. Similar words such as “connect” or “connected” are not limited to physical or mechanical connection, but can include electrical connection, whether direct or indirect. “Upper”, “lower”, “left” and “right” are only used to express a relative positional relationship, and when an absolute position of the described object changes, the relative positional relationship may change accordingly.

In the description of the disclosure, when it is considered that some detailed explanations about functions or configurations may unnecessarily obscure the essence of the disclosure, these detailed explanations will be omitted. All terms (including descriptive or technical terms) used herein should be interpreted as having meanings apparent to those of ordinary skill in the art. However, these terms may have different meanings according to the intention of those of ordinary skill in the art, precedents or the emergence of new technologies, and therefore, the terms used herein must be defined based on the meanings of these terms together with the description provided herein.

Hereinafter, for example, the base station may be at least one of a gNode B, an eNode B (eNB), a Node B, a radio access unit, a base station controller, and a node on a network. The terminal may include a user equipment (UE), a mobile station (MS), a mobile phone, a smart phone, a computer or multimedia system capable of performing communication functions. In some embodiments of the disclosure, the downlink (DL) is a wireless transmission path through which signals are transmitted from a base station to a terminal, and the uplink (UL) is a wireless transmission path through which signals are transmitted from a terminal to a base station.

The various embodiments discussed below for describing the principles of the disclosure herein are for illustration purposes only and should not be interpreted as limiting the scope of the disclosure in any way. Those skilled in the art will understand that the principles of the disclosure can be implemented in any suitably arranged wireless communication system. For example, although the following detailed description of the embodiments of the disclosure will be directed to 5G, those skilled in the art can understand that the main points of the disclosure can also be applied to other communication systems (for example, beyond 5G (B5G) or 6G) with similar technical backgrounds and channel formats with slight modifications without departing from the scope of the disclosure.

Hereinafter, the embodiments of the disclosure will be described in detail with reference to the accompanying drawings. It should be noted that the same reference numerals in different drawings will be used to refer to the same elements already described.

The fifth generation wireless communication system supports standalone mode of operation as well dual connectivity (DC). In DC, a multiple Rx/Tx UE may be configured to utilise resources provided by two different nodes (or NBs) connected via non-ideal backhaul. One node acts as the Master Node (MN) and the other as the Secondary Node (SN). The MN and SN are connected via a network interface and at least the MN is connected to the core network. NR also supports Multi-RAT Dual Connectivity (MR-DC) operation whereby a UE in radio resource control (RRC)_CONNECTED is configured to utilise radio resources provided by two distinct schedulers, located in two different nodes connected via a non-ideal backhaul and providing either E-UTRA (i.e. if the node is an ng-eNB) or NR access (i.e. if the node is a gNB). In NR, for a UE in RRC_CONNECTED not configured with carrier aggregation (CA)/DC, there is only one serving cell comprising of the primary cell. For a UE in RRC_CONNECTED configured with CA/DC, the term ‘serving cells’ is used to denote the set of cells comprising of the Special Cell(s) and all secondary cells. In NR, the term Master Cell Group (MCG) refers to a group of serving cells associated with the Master Node, comprising of the primary cell (PCell) and optionally one or more SCells. In NR, the term Secondary Cell Group (SCG) refers to a group of serving cells associated with the Secondary Node, comprising of the PSCell and optionally one or more SCells. In NR, PCell refers to a serving cell in MCG, operating on the primary frequency, in which the UE either performs the initial connection establishment procedure or initiates the connection re-establishment procedure. In NR, for a UE configured with CA, Scell is a cell providing additional radio resources on top of Special Cell. Primary SCG Cell (PSCell) refers to a serving cell in SCG in which the UE performs random access when performing the Reconfiguration with Sync procedure. For Dual Connectivity operation, the term SpCell (i.e. Special Cell) refers to the PCell of the MCG or the PSCell of the SCG, otherwise the term Special Cell refers to the PCell.

In the fifth generation wireless communication system, Physical Downlink Control Channel (PDCCH) is used to schedule DL transmissions on PDSCH and UL transmissions on PUSCH, where the Downlink Control Information (DCI) on PDCCH includes: Downlink assignments containing at least modulation and coding format, resource allocation, and hybrid-ARQ information related to DL-SCH; Uplink scheduling grants containing at least modulation and coding format, resource allocation, and hybrid-ARQ information related to UL-SCH. In addition to scheduling, PDCCH can be used to for: Activation and deactivation of configured PUSCH transmission with configured grant; Activation and deactivation of PDSCH semipersistent transmission; Notifying one or more UEs of the slot format; Notifying one or more UEs of the PRB(s) and OFDM symbol(s) where the UE may assume no transmission is intended for the UE; Transmission of TPC commands for PUCCH and PUSCH; Transmission of one or more TPC commands for SRS transmissions by one or more UEs; Switching a UE's active bandwidth part; Initiating a random access procedure. A UE monitors a set of PDCCH candidates in the configured monitoring occasions in one or more configured COntrol REsource SETs (CORESETs) according to the corresponding search space configurations. A CORESET consists of a set of PRBs with a time duration of 1 to 3 OFDM symbols. The resource units Resource Element Groups (REGs) and Control Channel Elements (CCEs) are defined within a CORESET with each CCE consisting a set of REGs. Control channels are formed by aggregation of CCE. Different code rates for the control channels are realized by aggregating different number of CCE. Interleaved and non-interleaved CCE-to-REG mapping are supported in a CORESET. Polar coding is used for PDCCH. Each resource element group carrying PDCCH carries its own DMRS. QPSK modulation is used for PDCCH.

In fifth generation wireless communication system, a list of search space configurations are signaled by GNB for each configured BWP wherein each search space configuration is uniquely identified by an identifier. Identifier of search space configuration to be used for specific purpose such as paging reception, SI reception, random access response reception is explicitly signaled by gNB. In NR search space configuration comprises of parameters Monitoring-periodicity-PDCCH-slot, Monitoring-offset-PDCCH-slot, Monitoring-symbols-PDCCH-within-slot and duration. A UE determines PDCCH monitoring occasion (s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are there in slots ‘x’ to x+duration where the slot with number ‘x’ in a radio frame with number ‘y’ satisfies the equation below:

(y*(number of slots in a radio frame)+x−Monitoring-offset-PDCCH-slot)mod (Monitoring-periodicity-PDCCH-slot)=0;
The starting symbol of a PDCCH monitoring occasion in each slot having PDCCH monitoring occasion is given by Monitoring-symbols-PDCCH-within-slot. The length (in symbols) of a PDCCH monitoring occasion is given in the corset associated with the search space. Search space configuration includes the identifier of coreset configuration associated with it. A list of coreset configurations are signaled by GNB for each configured BWP wherein each coreset configuration is uniquely identified by an identifier. Note that each radio frame is of 10 ms duration. Radio frame is identified by a radio frame number or system frame number. Each radio frame comprises of several slots wherein the number of slots in a radio frame and duration of slots depends on sub carrier spacing. The number of slots in a radio frame and duration of slots depends radio frame for each supported SCS is pre-defined in NR. Each coreset configuration is associated with a list of TCI (Transmission configuration indicator) states. One DL RS ID (SSB or CSI RS) is configured per TCI state. The list of TCI states corresponding to a coreset configuration is signaled by gNB via RRC signaling. One of the TCI state in TCI state list is activated and indicated to UE by gNB. TCI state indicates the DL TX beam (DL TX beam is QCLed with SSB/CSI RS of TCI state) used by GNB for transmission of PDCCH in the PDCCH monitoring occasions of a search space.

In fifth generation wireless communication system, bandwidth adaptation (BA) is supported. With BA, the receive and transmit bandwidth of a UE need not be as large as the bandwidth of the cell and can be adjusted: the width can be ordered to change (e.g. to shrink during period of low activity to save power); the location can move in the frequency domain (e.g. to increase scheduling flexibility); and the subcarrier spacing can be ordered to change (e.g. to allow different services). A subset of the total cell bandwidth of a cell is referred to as a Bandwidth Part (BWP). BA is achieved by configuring RRC connected UE with BWP(s) and telling the UE which of the configured BWPs is currently the active one. When BA is configured, the UE only has to monitor PDCCH on the one active BWP i.e. it does not have to monitor PDCCH on the entire DL frequency of the serving cell. In RRC connected state, UE is configured with one or more DL and UL BWPs, for each configured Serving Cell (i.e. PCell or SCell). For an activated Serving Cell, there is always one active UL and DL BWP at any point in time. The BWP switching for a Serving Cell is used to activate an inactive BWP and deactivate an active BWP at a time. The BWP switching is controlled by the PDCCH indicating a downlink assignment or an uplink grant, by the bwpInactivityTimer, by RRC signaling, or by the MAC entity itself upon initiation of Random Access procedure. Upon addition of SpCell or activation of an SCell, the DL BWP and UL BWP indicated by firstActiveDownlinkBWP-Id and firstActiveUplinkBWP-Id respectively is active without receiving PDCCH indicating a downlink assignment or an uplink grant. The active BWP for a Serving Cell is indicated by either RRC or PDCCH. For unpaired spectrum, a DL BWP is paired with a UL BWP, and BWP switching is common for both UL and DL. Upon expiry of BWP inactivity timer UE switch to the active DL BWP to the default DL BWP or initial DL BWP (if default DL BWP is not configured).

In the fifth generation wireless communication system, RRC can be in one of the following states: RRC_IDLE, RRC_INACTIVE, and RRC_CONNECTED. A UE is either in RRC_CONNECTED state or in RRC_INACTIVE state when an RRC connection has been established. If this is not the case, i.e. no RRC connection is established, the UE is in RRC_IDLE state. The RRC states can further be characterized as follows:

In the RRC_IDLE, a UE specific Discontinuous Reception (DRX) may be configured by upper layers. The UE monitors short Messages transmitted with P-RNTI over DCI; monitors a Paging channel for core network (CN) paging using 5G-S-TMSI; performs neighboring cell measurements and cell (re-)selection; acquires system information and can send SI request (if configured); performs logging of available measurements together with location and time for logged measurement configured UEs.

In RRC_INACTIVE, a UE specific DRX may be configured by upper layers or by RRC layer; UE stores the UE Inactive AS context; a RAN-based notification area is configured by RRC layer. The UE monitors Short Messages transmitted with P-RNTI over DCI; monitors a Paging channel for CN paging using 5G-S-TMSI and RAN paging using fullI-RNTI; performs neighbouring cell measurements and cell (re-)selection; performs RAN-based notification area updates periodically and when moving outside the configured RAN-based notification area; acquires system information and can send SI request (if configured); performs logging of available measurements together with location and time for logged measurement configured UEs.

In the RRC_CONNECTED, the UE stores the AS context and transfer of unicast data to/from UE takes place. The UE monitors Short Messages transmitted with P-RNTI over DCI, if configured; monitors control channels associated with the shared data channel to determine if data is scheduled for it; provides channel quality and feedback information; performs neighbouring cell measurements and measurement reporting; acquires system information.

The 5G or Next Generation Radio Access Network (NG-RAN) based on NR consists of NG-RAN nodes where NG-RAN node is a gNB, providing NR user plane and control plane protocol terminations towards the UE. The gNBs are also connected by means of the NG interfaces to the 5GC, more specifically to the Access and Mobility Management Function (AMF) by means of the NG-C interface and to the UPF (User Plane Function) by means of the NG-U interface.

In the 5th generation (also referred as NR or New Radio) wireless communication system, the UE may use Discontinuous Reception (DRX) in RRC_IDLE and RRC_INACTIVE state in order to reduce power consumption. In the RRC_IDLE/RRC_INACTIVE state UE wake ups at regular intervals (i.e. every DRX cycle) for short periods to receive paging, to receive SI update notification and to receive emergency notifications. Paging message is transmitted using physical downlink shared channel (PDSCH). Physical downlink common control channel (PDCCH) is addressed to P-RNTI if there is a paging message in PDSCH. P-RNTI is common for all UEs. UE identity (i.e. S-TMSI for RRC_IDLE UE or I-RNTI for RRC_INACTIVE UE) is included in paging message to indicate paging for a specific UE. Paging message may include multiple UE identities to page multiple UEs. Paging message is broadcasted (i.e. PDCCH is masked with P-RNTI) over data channel (i.e. PDSCH). SI update and emergency notifications are included in DCI and PDCCH carrying this DCI is addressed to P-RNTI. In the RRC idle/inactive mode UE monitors one paging occasion (PO) every DRX cycle. In the RRC idle/inactive mode UE monitors PO in initial DL BWP. In RRC connected state UE monitors one or more POs to receive SI update notification and to receive emergency notifications. UE can monitor any PO in paging DRX cycle and monitors at least one PO in SI modification period. In the RRC idle/inactive mode UE monitors PO in its active DL BWP. A PO is a set of ‘S’ PDCCH monitoring occasions for paging, where ‘S’ is the number of transmitted SSBs (i.e. the Synchronization Signal and PBCH block (SSB) consists of primary and secondary synchronization signals (PSS, SSS) and PBCH) in cell. UE first determines the paging frame (PF) and then determines the PO with respect to the determined PF. One PF is a radio frame (10 ms).
The PF for a UE is the radio frame with system frame number ‘SFN’ which satisfies the equation (SFN+PF_offset) mod T=(T div N)*(UE_ID mod N).
Index (is), indicating the index of the PO is determined by is =floor(UE_ID/N) mod Ns.
T is DRX cycle of the UE.
In RRC_INACTIVE state, T is determined by the shortest of the UE specific DRX value configured by RRC, UE specific DRX value configured by non-access stratum (NAS), and a default DRX value broadcast in system information.
In RRC_IDLE state, T is determined by the shortest of UE specific DRX value configured by NAS, and a default DRX value broadcast in system information. If UE specific DRX is not configured by upper layers (i.e. NAS), the default value is applied.
N: number of total paging frames in T
Ns: number of paging occasions for a PF
PF_offset: offset used for PF determination
UE_ID: 5G-S-TMSI mod 1024
Parameters Ns, nAndPagingFrameOffset, and the length of default DRX Cycle are signaled in SIB1. The values of N and PF_offset are derived from the parameter nAndPagingFrameOffset as defined in TS 38.331. If the UE has no 5G-S-TMSI, for instance when the UE has not yet registered onto the network, the UE shall use as default identity UE_ID=0 in the PF and i_s formulas above.
The PDCCH monitoring occasions for paging are determined based on paging search space configuration (paging-SearchSpace) signaled by gNB.
When SearchSpaceId=0 is configured for pagingSearchSpace, the PDCCH monitoring occasions for paging are same as for RMSI as defined in clause 13 in TS 38.213. When SearchSpaceId=0 is configured for pagingSearchSpace, Ns is either 1 or 2. For Ns=1, there is only one PO which starts from the first PDCCH monitoring occasion for paging in the PF. For Ns=2, PO is either in the first half frame (is =0) or the second half frame (is =1) of the PF.
When SearchSpaceId other than 0 is configured for pagingSearchSpace, the UE monitors the (i_s+1)th PO. The PDCCH monitoring occasions for paging are determined based on paging search space configuration (paging-SearchSpace) signaled by gNB. The PDCCH monitoring occasions for paging which are not overlapping with UL symbols (determined according to tdd-UL-DL-ConfigurationCommon) are sequentially numbered from zero starting from the 1st PDCCH monitoring occasion for paging in the PF. The gNB may signal parameter firstPDCCH-MonitoringOccasionOfPO for each PO corresponding to a PF. When firstPDCCH-MonitoringOccasionOfPO is signalled, the (i_s+1)th PO is a set of ‘S’ consecutive PDCCH monitoring occasions for paging starting from the PDCCH monitoring occasion number indicated by firstPDCCH-MonitoringOccasionOfPO (i.e. the (i_s+1)th value of the firstPDCCH-MonitoringOccasionOfPO parameter). Otherwise, the (i_s+1)th PO is a set of ‘S’ consecutive PDCCH monitoring occasions for paging starting from the (i_s*S)th PDCCH monitoring occasion for paging. ‘S’ is the number of actual transmitted SSBs determined according to parameter ssb-PositionsInBurst signalled in SystemInformationBlock1 received from gNB. The parameter firstPDCCH-MonitoringOccasionOfPO is signalled in SIB1 for paging in initial DL BWP. For paging in a DL BWP other than the initial DL BWP, the parameter firstPDCCH-MonitoringOccasionOfPO is signaled in the corresponding BWP configuration.

The PDCCH addressed to P-RNTI carries information according to DCI format 1_0. The following information is transmitted by means of the DCI format 1_0 with CRC scrambled by P-RNTI:
Short Messages Indicator—2 bits according to Table 1.
Short Messages—8 bits according to Table 2. If only the scheduling information for Paging is carried, this bit field is reserved.
Frequency domain resource assignment—┌log₂(N_{RB}^{DL,BWP}(N_{RV}^{DL,BWP}+1)/2)┐ bits. If only the short message is carried, this bit field is reserved.
N_{RB}^{DL,BWP} is the size of CORESET 0
Time domain resource assignment—4 bits. If only the short message is carried, this bit field is reserved.
VRB-to-PRB mapping—1 bit. If only the short message is carried, this bit field is reserved.
Modulation and coding scheme—5 bits. If only the short message is carried, this bit field is reserved.
TB scaling—2 bits. If only the short message is carried, this bit field is reserved.
Reserved bits—6 bits

Table 1 shows an example of a bit field of short message indicator.

TABLE 1

| Bit field | Short Message indicator |
|---|---|
| 00 | Reserved |
| 01 | Only scheduling information for Paging is present in the DCI |
| 10 | Only short message is present in the DCI |
| 11 | Both scheduling information for Paging and short message are |
| | present in the DCI |

Table 2 defines Short Message. Bit 1 is the most significant bit.

TABLE 2

| Bit | Short Message |
|---|---|
| 1 | systemInfoModification |
| | If set to 1: indication of a BCCH modification other than SIB6, |
| | SIB7 and SIB8. |
| 2 | etwsAndCmasIndication |
| | If set to 1: indication of an ETWS primary notification and/or an |
| | ETWS secondary notification and/or a CMAS notification. |
| 3-8 | Reserved |

Early paging indication is supported before the paging occasion. Early paging indication indicates paging for one or more paging subgroups. UE may identify its paging subgroup in one of the following ways:

Paging sub group identity (ID) is assigned by CN (i.e. by AMF using NAS message), or

Paging sub group identity is determined based on UE_ID (e.g., UE_ID is 5G-S-TMSI or 5G-S-TMSI mod X, where X is 1024 or 2048 or 4096 or N*Ns*P or Max value of N*Max value of Ns*Max value of P)
UE belongs to sub group ‘k’=floor(UE_ID/(N*Ns)) mod P, where
N is the number of Paging frames, Ns is the number of POs per paging frame and
P is the number of paging sub groups.

The issue is selection of paging subgrouping method for monitoring early paging indication by the UE.

### Early Paging Indication Monitoring

### Embodiment 1

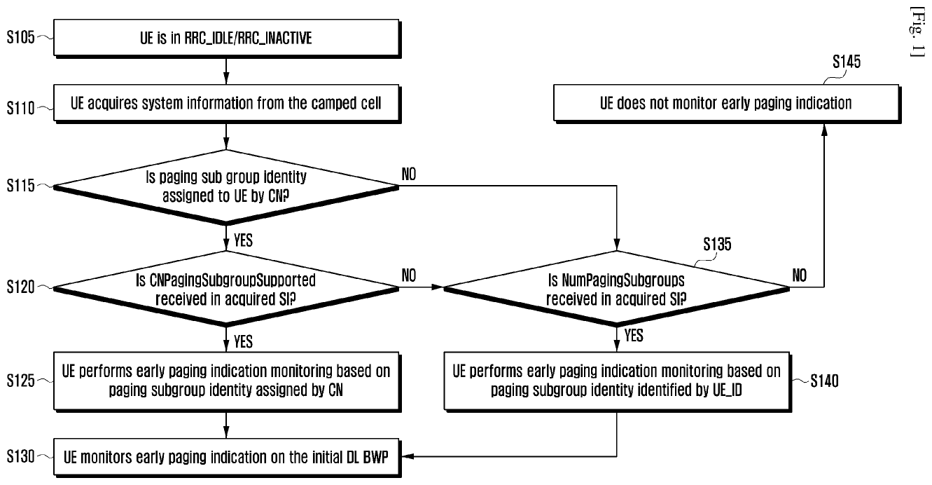

FIG. 1 illustrates an example of UE operation for monitoring early paging indication according to an embodiment of the disclosure.

Referring to FIG. 1, UE may be in RRC_IDLE or RRC_INACTIVE state (S105).

A cell broadcasts/signals a parameter ‘CNPagingSubgroupSupported’ in SIB (e.g. SIB1 or any other SIB). The parameter may be signalled if the cell supports CN paging subgroups (i.e. paging sub groups assigned by CN (i.e. network/AMF)). The parameter ‘CNPagingSubgroupSupported’ may be included in SIB and set to TRUE if the cell supports CN paging subgroups (i.e. paging sub groups assigned by CN (network/AMF)). The parameter ‘CNPagingSubgroupSupported’ may also be known as ‘NetworkPagingSubgroupSupported’.

The cell broadcasts/signals the parameter ‘NumPagingSubgroups’ in SIB (e.g. SIB1 or any other SIB). The parameter may be signalled if the cell supports UE ID based subgrouping. The parameter may indicate the number of paging subgroups (or the number of paging subgroups for UE ID based subgrouping).

UE acquires SIB from the camped cell (S110).

UE identifies whether a paging subgroup identity is assigned by CN (e.g., network/AMF) (S115) to the UE. In case that the paging subgroup identity is assigned by CN, UE identifies whether ‘CNPagingSubgroupSupported’ parameter is received in the acquired SIB (S120) (or UE identifies whether the camped cell supports CN based paging subgrouping).

(Cond1) If UE has paging subgroup identity assigned by CN (network/AMF) and ‘CNPagingSubgroupSupported’ is received in SIB from the camped cell (or camped cell supports CN based paging subgrouping):
UE may perform early paging indication monitoring based on paging subgroup identity assigned by CN (network/AMF) (S125).
UE determines PF and PO as described earlier. UE then identifies the occasion(s) for monitoring early paging indication corresponding to the determined PF/PO and monitors for early paging indication in the identified occasions (S130).
UE checks whether the early paging indication indicates paging for its paging sub group assigned by CN. For example, if UE paging sub group identity based on UE ID is 2 and UE paging sub group identity assigned by CN is 3, UE checks whether the early paging indication indicates paging for paging sub group 3 or not. If yes, UE monitors PO and receives the paging message scheduled by PDCCH addressed to P-RNTI received in PDCCH monitoring occasion of monitored PO.
Early paging indication may indicate paging for a paging sub group by including paging sub group identity in the DCI of PDCCH for early paging indication or by setting the bit in bitmap corresponding to the paging sub group identity in the DCI of PDCCH for early paging indication or by transmitting a sequence corresponding to the paging sub group identity in the monitoring occasion for early paging indication. Note that early paging indication may be transmitted before the PO. The PDCCH for early paging indication may be addressed to a pre-defined RNTI or RNTI signaled by gNB in system information. In an embodiment, there may be multiple RNTIs for monitoring early paging indication wherein a different RNTI is associated with a different PO of a PF. For example, if the PO index (is) determined by UE is 0, UE monitors PDCCH addressed to first RNTI in the PDCCH monitoring occasion of early paging indication; if the PO index (is) determined by UE is 1, UE monitors PDCCH addressed to second RNTI in the PDCCH monitoring occasion of early paging indication; if the PO index (is) determined by UE is 2, UE monitors PDCCH addressed to third RNTI in the PDCCH monitoring occasion of early paging indication, if the PO index (is) determined by UE is 3, UE monitors PDCCH addressed to four RNTI in the PDCCH monitoring occasion of early paging indication. The first, second, third and fourth RNTI may be pre-defined or signaled by gNB in system information/RRC message. List of RNTIs for early paging indication may be signaled by GNB in system information/RRC message wherein the first entry in the list corresponds to 1st PO (i.e. PO with index i_s=0), second entry in the list corresponds to 2nd PO (i.e. PO with index i_s=1), third entry in the list corresponds to 3rd PO (i.e. PO with index i_s=2) and fourth entry in the list corresponds to 4th PO (i.e. PO with index i_s=3).

(cond2) Else if ‘NumPagingSubgroups’ is received in SIB from the camped cell (i.e., if i) the paging subgroup identity is not assigned by CN, or ii) the paging subgroup identity is assigned by CN and ‘CNPagingSubgroupSupported’ parameter is not received in the acquired SIB (i.e. camped cell does not support CN based paging subgrouping), UE identifies whether ‘NumPagingSubgroups’ is received in SIB (S135) (i.e. camped cell supports UE ID based subgrouping)):
UE may perform early paging indication monitoring based on paging subgroup identity determined by UE ID (S140).
UE determines PF and PO as described earlier. UE then identifies the occasion(s) for monitoring early paging indication corresponding to the determined PF/PO and monitors for early paging indication in the identified occasions.
UE checks whether the early paging indication indicates paging for it paging sub group based on UE ID. For example, if UE paging sub group identity based on UE ID is 2, UE checks whether the early paging indication indicates paging for paging sub group 2 or not. If yes, UE monitors PO and receives the paging message scheduled by PDCCH addressed to P-RNTI received in PDCCH monitoring occasion of monitored PO.
Early paging indication may indicate paging for a paging sub group by including paging sub group identity in the DCI of PDCCH for early paging indication or by setting the bit in bitmap corresponding to the paging sub group identity in the DCI of PDCCH for early paging indication or by transmitting a sequence corresponding to the paging sub group identity in the monitoring occasion for early paging indication. Note that early paging indication is transmitted before the PO. The PDCCH for early paging indication may be addressed to a pre-defined RNTI or RNTI signaled by gNB in system information. In an embodiment, there may be multiple RNTIs for monitoring early paging indication wherein a different RNTI is associated with a different PO of a PF. For example, if the PO index (is) determined by UE is 0, UE monitors PDCCH addressed to first RNTI in the PDCCH monitoring occasion of early paging indication; if the if the PO index (is) determined by UE is 1, UE monitors PDCCH addressed to second RNTI in the PDCCH monitoring occasion of early paging indication; if the PO index (is) determined by UE is 2, UE monitors PDCCH addressed to third RNTI in the PDCCH monitoring occasion of early paging indication, if the PO index (is) determined by UE is 3, UE monitors PDCCH addressed to four RNTI in the PDCCH monitoring occasion of early paging indication. The first, second, third and fourth RNTI can be pre-defined or signaled by gNB in system information/RRC message. List of RNTIs for early paging indication may be signaled by GNB in system information/RRC message wherein the first entry in list corresponds to 1st PO (i.e. PO with index i_s=0), second entry in list corresponds to 2nd PO (i.e. PO with index i_s=1), third entry in list corresponds to 3rd PO (i.e. PO with index i_s=2) and fourth entry in list corresponds to 4th PO (i.e. PO with index i_s=3)

Else (i.e. both cond1 and cond2 are not met)
UE does not monitor early paging indication (S145).

Table 3 summarizes the selection of UE ID based paging sub group or CN assigned paging sub group for early paging indication monitoring according to whether paging subgroup is assigned to UE by CN or not, whether camped cell supports CN assigned paging sub groups and whether camped cell supports UE ID based sub grouping or not.

TABLE 3

| | | Camped Cell supports UE | Paging indication |
|---|---|---|---|
| Paging subgroup | Camped Cell supports CN | ID based sub grouping | monitoring based on |
| assigned to | assigned paging sub groups | (e.g. presence of number | paging subgroup |
| UE by CN | (e.g. CNPagingSubgroupSupported | of UE ID based paging sub | assigned by CN or |
| (network/AMF) | is signalled in SIB) | groups in SIB) | based on UE ID |
| Yes | Yes | Yes | CN assigned |
| Yes | No | Yes | UE ID based |
| No | Yes | Yes | UE ID based |
| No | No | Yes | UE ID based |
| Yes | Yes | No | CN assigned |
| Yes | No | No | No sub grouping |
| No | Yes | No | No sub grouping |
| No | No | No | No sub grouping |

### Embodiment 2

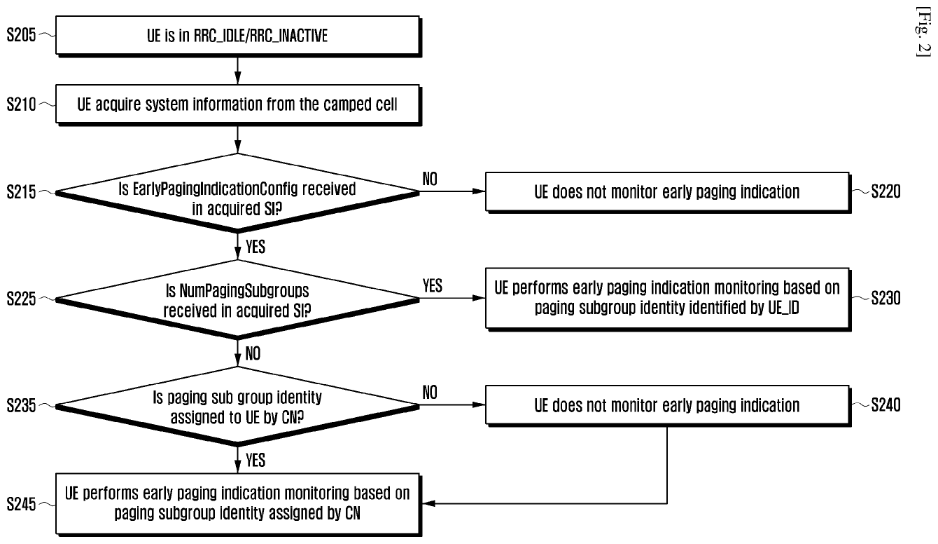

FIG. 2 illustrates another example of UE operation for monitoring early paging indication according to an embodiment of the disclosure.

Referring to FIG. 2, UE may be in RRC_IDLE or RRC_INACTIVE state (S205).

A cell broadcasts/signals a parameter ‘EarlyPagingIndicationConfig’ in SIB (e.g. SIB1 or any other SIB). The parameter is signalled if cell supports early paging indication.

The cell broadcasts/signals the parameter ‘NumPagingSubgroups’ in SIB (e.g. SIB1 or any other SIB). The parameter is signalled if the cell supports UE ID based subgrouping. The parameter indicates the number of paging subgroups (or the number of paging subgroups for UE ID based subgrouping). For example, this parameter may be not included if cell supports CN (network/AMF) assigned subgrouping and supports early paging indication.

UE acquires SIB from the camped cell (S210).

UE identifies whether a parameter ‘EarlyPagingIndicationConfig’ is received in SIB from the camped cell (S215). UE identifies whether a parameter ‘NumPagingSubgroups’ is received in SIB from the camped cell (S225). UE identifies whether a paging subgroup identity is assigned by CN (network/AMF) (S235).

If ‘EarlyPagingIndicationConfig’ is received in SIB from the camped cell, and ‘NumPagingSubgroups’ is not received in SIB from the camped cell, and UE has paging subgroup identity assigned by CN (network/AMF):
UE may perform early paging indication monitoring based on paging subgroup identity assigned by CN (network/AMF) (S245).
UE determines PF and PO as described earlier. UE then identifies the occasion(s) for monitoring early paging indication corresponding to the determined PF/PO and monitors for early paging indication in the identified occasions.
UE checks whether the early paging indication indicates paging for it paging sub group assigned by CN. For example, if UE paging sub group identity is 2 based on UE ID and UE paging sub group identity assigned by CN is 3, UE checks whether the early paging indication indicates paging for paging sub group 3 or not. If yes, UE monitors PO and receives the paging message scheduled by PDCCH addressed to PRNTI received in PDCCH monitoring occasion of monitored PO.
Early paging indication may indicate paging for a paging sub group by including paging sub group identity in the DCI of PDCCH for early paging indication or by setting the bit in bitmap corresponding to the paging sub group identity in the DCI of PDCCH for early paging indication or by transmitting a sequence corresponding to the paging sub group identity in the monitoring occasion for early paging indication. Note that early paging indication is transmitted before the PO. The PDCCH for early paging indication may be addressed to a pre-defined RNTI or RNTI signaled by gNB in system information. In an embodiment, there may be multiple RNTIs for monitoring early paging indication wherein a different RNTI is associated with a different PO of a PF. For example, if the PO index (is) determined by UE is 0, UE monitors PDCCH addressed to first RNTI in the PDCCH monitoring occasion of early paging indication; if the if the PO index (is) determined by UE is 1, UE monitors PDCCH addressed to second RNTI in the PDCCH monitoring occasion of early paging indication; if the PO index (is) determined by UE is 2, UE monitors PDCCH addressed to third RNTI in the PDCCH monitoring occasion of early paging indication, if the PO index (is) determined by UE is 3, UE monitors PDCCH addressed to four RNTI in the PDCCH monitoring occasion of early paging indication. The first, second, third and fourth RNTI may be pre-defined or signaled by gNB in system information/RRC message. List of RNTIs for early paging indication may be signaled by GNB in system information/RRC message wherein the first entry in list corresponds to 1st PO (i.e. PO with index i_s=0), second entry in list corresponds to 2nd PO (i.e. PO with index i_s=1), third entry in list corresponds to 3rd PO (i.e. PO with index i_s=2) and fourth entry in list corresponds to 4th PO (i.e. PO with index i_s=3).

Else if ‘EarlyPagingIndicationConfig’ is received in SIB from the camped cell and if ‘NumPagingSubgroups’ is received in SIB:
UE may perform early paging indication monitoring based on paging subgroup identity determined by UE ID (S230).
UE determines PF and PO as described earlier. UE then identifies the occasion(s) for monitoring early paging indication corresponding to the determined PF/PO and monitors for early paging indication in the identified occasions.
UE checks whether the early paging indication indicates paging for it paging sub group based on UE ID. For example, if UE paging sub group identity based on UE ID is 2, UE checks whether the early paging indication indicates paging for paging sub group 2 or not. If yes, UE monitors PO and receives the paging message scheduled by PDCCH addressed to P-RNTI received in PDCCH monitoring occasion of monitored PO.
Early paging indication may indicate paging for a paging sub group by including paging sub group identity in the DCI of PDCCH for early paging indication or by setting the bit in bitmap corresponding to the paging sub group identity in the DCI of PDCCH for early paging indication or by transmitting a sequence corresponding to the paging sub group identity in the monitoring occasion for early paging indication. Note that early paging indication is transmitted before the PO. The PDCCH for early paging indication may be addressed to a pre-defined RNTI or RNTI signaled by gNB in system information. In an embodiment, there may be multiple RNTIs for monitoring early paging indication wherein a different RNTI is associated with a different PO of a PF. For example, if the PO index (is) determined by UE is 0, UE monitors PDCCH addressed to first RNTI in the PDCCH monitoring occasion of early paging indication; if the if the PO index (is) determined by UE is 1, UE monitors PDCCH addressed to second RNTI in the PDCCH monitoring occasion of early paging indication; if the PO index (is) determined by UE is 2, UE monitors PDCCH addressed to third RNTI in the PDCCH monitoring occasion of early paging indication, if the PO index (is) determined by UE is 3, UE monitors PDCCH addressed to four RNTI in the PDCCH monitoring occasion of early paging indication. The first, second, third and fourth RNTI can be pre-defined or signaled by gNB in system information/RRC message. List of RNTIs for early paging indication may be signaled by GNB in system information/RRC message wherein the first entry in list corresponds to 1st PO (i.e. PO with index i_s=0), second entry in list corresponds to 2nd PO (i.e. PO with index i_s=1), third entry in list corresponds to 3rd PO (i.e. PO with index i_s=2) and fourth entry in list corresponds to 4th PO (i.e. PO with index i_s=3).

Else (i.e., i) if ‘EarlyPagingIndicationConfig’ is not received in SIB from the camped cell or ii) if ‘EarlyPagingIndicationConfig’ is received in SIB from the camped cell, and ‘NumPagingSubgroups’ is not received in SIB from the camped cell, and UE has no paging subgroup identity assigned by CN (network/AMF)):
UE does not monitor early paging indication (S220, S240).

Table 4 summarizes the selection of UE ID based paging sub group or CN assigned paging sub group for early paging indication monitoring according to whether paging subgroup is assigned to UE by CN or not, whether camped cell supports early paging indication and whether camped cell supports UE ID based sub grouping or not.

TABLE 4

| | | Camped Cell supports | Paging indication |
|---|---|---|---|
| | | UE ID based grouping | monitoring based on |
| | | (e.g. presence of | paging subgroup |
| EarlyPagingIndica- | Paging subgroup | number of paging sub | assigned by CN or |
| tionConfig | assigned to UE by CN | groups in SIB) | based on UE ID |
| Yes | Yes | No | NW assigned |
| Yes | No | Yes | UE ID based |
| Yes | Yes | Yes | UE ID based |
| Yes | No | No | No sub grouping |
| No | X (Yes/No) | — | No sub grouping |

Alternatively, if ‘EarlyPagingIndicationConfig’ is received in SIB from the camped cell and ‘NumPagingSubgroups’ is not received in SIB from the camped cell and UE has paging subgroup identity assigned by CN:
UE may perform early paging indication monitoring based on paging subgroup identity assigned by CN (S245).

Else if ‘EarlyPagingIndicationConfig’ is received in SIB from the camped cell and if ‘NumPagingSubgroups’ is received in SIB and UE does not have paging subgroup identity assigned by CN:
UE may perform early paging indication monitoring based on paging subgroup identity determined by UE_ID (S230).

Otherwise, UE does not monitor early paging indication.

### Embodiment 3

In an embodiment of the disclosure, a cell broadcasts/signals the parameter ‘CNPagingSubgroupSupported’ in SIB (e.g. SIB1). The parameter may be signalled if the cell supports CN paging subgroups (i.e. paging sub groups assigned by CN). The parameter ‘CNPagingSubgroupSupported’ may be included in SIB and set to TRUE if the cell supports CN paging subgroups (i.e. paging sub groups assigned by CN). The parameter ‘CNPagingSubgroupSupported’ may also be known as ‘NetworkPagingSubgroupSupported’.

The cell broadcasts/signals the parameter ‘NumPagingSubgroups’ in SIB (e.g. SIB1). The parameter may be signalled if the cell supports UE ID based subgrouping. The parameter indicates the number of paging subgroups (or the number of paging subgroups for UE ID based subgrouping).

UE acquires SIB from the camped cell.

If ‘CNPagingSubgroupSupported’ is received in SIB from the camped cell and if ‘NumPagingSubgroups’ is received in SIB from the camped cell:
See details under ‘Handling for the case camped cell supports both CN based and UE ID based grouping’

Else If ‘CNPagingSubgroupSupported’ is not received in SIB and if ‘NumPagingSubgroups’ is received in SIB from the camped cell:
UE may perform early paging indication monitoring based on paging subgroup identity determined by UE ID.
UE determines PF and PO as described earlier. UE then identifies the occasion(s) for monitoring early paging indication corresponding to the determined PF/PO and monitors for early paging indication in the identified occasions.
UE checks whether the early paging indication indicates paging for its paging sub group based on UE ID. For example, if UE paging sub group identity based on UE ID is 2, UE checks whether the early paging indication indicates paging for paging sub group 2 or not. If yes, UE monitors PO and receives the paging message scheduled by PDCCH addressed to P-RNTI received in PDCCH monitoring occasion of monitored PO.
Early paging indication may indicate paging for a paging sub group by including paging sub group identity in the DCI of PDCCH for early paging indication or by setting the bit in bitmap corresponding to the paging sub group identity in the DCI of PDCCH for early paging indication or by transmitting a sequence corresponding to the paging sub group identity in the monitoring occasion for early paging indication. Note that early paging indication is transmitted before the PO. The PDCCH for early paging indication may be addressed to a pre-defined RNTI or RNTI signaled by gNB in system information. In an embodiment, there may be multiple RNTIs for monitoring early paging indication wherein a different RNTI is associated with a different PO of a PF. For example, if the PO index (is) determined by UE is 0, UE monitors PDCCH addressed to first RNTI in the PDCCH monitoring occasion of early paging indication; if the if the PO index (is) determined by UE is 1, UE monitors PDCCH addressed to second RNTI in the PDCCH monitoring occasion of early paging indication; if the PO index (is) determined by UE is 2, UE monitors PDCCH addressed to third RNTI in the PDCCH monitoring occasion of early paging indication, if the PO index (is) determined by UE is 3, UE monitors PDCCH addressed to four RNTI in the PDCCH monitoring occasion of early paging indication. The first, second, third and fourth RNTI may be pre-defined or signaled by gNB in system information/RRC message. List of RNTIs for early paging indication may be signaled by GNB in system information/RRC message wherein the first entry in list corresponds to 1st PO (i.e. PO with index i_s=0), second entry in list corresponds to 2nd PO (i.e. PO with index i_s=1), third entry in list corresponds to 3rd PO (i.e. PO with index i_s=2) and fourth entry in list corresponds to 4th PO (i.e. PO with index i_s=3).

Else if ‘CNPagingSubgroupSupported’ is received in SIB and if ‘NumPagingSubgroups’ is not received in SIB from the camped cell and if UE has paging subgroup identity assigned by CN:
UE may perform early paging indication monitoring based on paging subgroup identity assigned by CN (network/AMF).
UE determines PF and PO as described earlier. UE then identifies the occasion(s) for monitoring early paging indication corresponding to the determined PF/PO and monitors for early paging indication in the identified occasions.
UE checks whether the early paging indication indicates paging for its paging sub group assigned by CN. For example, if UE paging sub group identity based on UE ID is 2 and UE paging sub group identity assigned by CN is 3, UE checks whether the early paging indication indicates paging for paging sub group 3 or not. If yes, UE monitors PO and receives the paging message scheduled by PDCCH addressed to PRNTI received in PDCCH monitoring occasion of monitored PO.
Early paging indication may indicate paging for a paging sub group by including paging sub group identity in the DCI of PDCCH for early paging indication or by setting the bit in bitmap corresponding to the paging sub group identity in the DCI of PDCCH for early paging indication or by transmitting a sequence corresponding to the paging sub group identity in the monitoring occasion for early paging indication. Note that early paging indication is transmitted before the PO. The PDCCH for early paging indication may be addressed to a pre-defined RNTI or RNTI signaled by gNB in system information. In an embodiment, there may be multiple RNTIs for monitoring early paging indication wherein a different RNTI is associated with a different PO of a PF. For example, if the PO index (is) determined by UE is 0, UE monitors PDCCH addressed to first RNTI in the PDCCH monitoring occasion of early paging indication; if the if the PO index (is) determined by UE is 1, UE monitors PDCCH addressed to second RNTI in the PDCCH monitoring occasion of early paging indication; if the PO index (is) determined by UE is 2, UE monitors PDCCH addressed to third RNTI in the PDCCH monitoring occasion of early paging indication, if the PO index (is) determined by UE is 3, UE monitors PDCCH addressed to four RNTI in the PDCCH monitoring occasion of early paging indication. The first, second, third and fourth RNTI may be pre-defined or signaled by gNB in system information/RRC message. List of RNTIs for early paging indication may be signaled by GNB in system information/RRC message wherein the first entry in list corresponds to 1st PO (i.e. PO with index i_s=0), second entry in list corresponds to 2nd PO (i.e. PO with index i_s=1), third entry in list corresponds to 3rd PO (i.e. PO with index i_s=2) and fourth entry in list corresponds to 4th PO (i.e. PO with index i_s=3).

Else
UE does not monitor early paging indication.

### Handling for the Case Camped Cell Supports Both CN Based and UE ID Based Grouping

### Case 1: UE has Paging Subgroup Assigned by CN

In option 1-1, UE may use both its paging subgroup assigned by CN and paging subgroup identified based on UE ID for monitoring early paging indication.

If the early paging indication includes a bitmap wherein each bit of the bitmap corresponds to a paging sub group, UE checks for a bit in the bitmap corresponding to its paging subgroup assigned by CN and paging subgroup based on UE ID.

In an embodiment, if ‘X’ is the number of paging subgroups based on UE ID and if ‘Y’ is the number of paging sub groups assigned by CN, Y sets of bits where each set consists of ‘X’ bits can be there in early paging indication. Each set of ‘X’ bits is mapped to a distinct paging sub group assigned by CN. Each bit in the set is mapped to a distinct paging sub group based on UE ID. Each of these ‘Y’ sets of bits, can be a separate bitmap or it can be part of a bitmap.

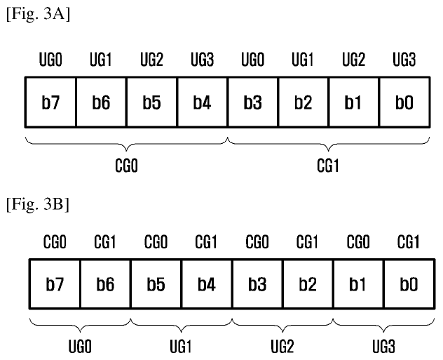

FIG. 3A illustrates an example of a bitmap corresponding to paging subgroups according to an embodiment of the disclosure.

Referring to FIG. 3A, maximum number of CN paging sub groups is 2 (i.e. Y equals 2) and maximum number of UE ID based subgroups is 4 (i.e. X=4). There are two sets of 4 bits each, where each set is mapped to one of two CN paging sub groups (e.g., CG 0 and CG 1). Each bit in the set of 4 bits is mapped to one of four UE ID based Paging sub groups (e.g., UG0 to UG 3). If UE's subgroup assigned by CN is 1 and a subgroup based on UE ID is 3, UE checks b0. If b0 is set to 1, UE monitors PO and receives the paging message scheduled by PDCCH received in monitored PO.

In another embodiment, If ‘X’ is the number of paging subgroups based on UE ID and if ‘Y’ is the number of paging sub groups assigned by CN, X sets of bits where each set consists of ‘Y’ bits may be there in early paging indication. Each set of ‘Y’ bits is mapped to a distinct paging sub group based on UE ID. Each bit in the set is mapped to a distinct paging sub group assigned by CN. Each of these ‘X’ sets of bits, can be a separate bitmap or it can be part of a bitmap.

FIG. 3B illustrates another example of a bitmap corresponding to paging subgroups according to an embodiment of the disclosure.

Referring to FIG. 3B, maximum number of CN paging sub groups is 2 (i.e. Y equals 2) and maximum number of UE ID based groups is 4 (i.e. X=4). There are four sets of 2 bits each, where each set is mapped to one of four UE ID based paging sub groups (e.g., UG 0 to UG3). Each bit in the set of 2 bits is mapped to one of two CN assigned Paging sub groups (e.g., CGO to CG 1). If UE's subgroup assigned by CN is 1 and subgroup based on UE ID is 2, UE checks b2. If b2 is set to 1, UE monitors PO and receives the paging message scheduled by PDCCH received in monitored PO.

FIG. 4 illustrates various ways of mapping bits to CN assigned paging sub groups and UE ID based paging sub groups according to an embodiment of the disclosure. FIG. 4 illustrates the case the max number of CN paging sub groups is 2 (i.e. Y equals 2) and maximum number of UE ID based groups is 4 (i.e. X=4). However, this may be applied for any values of X and Y.

In option 1-2, UE may use paging subgroup assigned by CN for monitoring early paging indication.

If the early paging indication includes a bitmap wherein each bit of the bitmap corresponds to a paging sub group, UE checks for a bit in the bitmap corresponding to its paging subgroup assigned by CN.

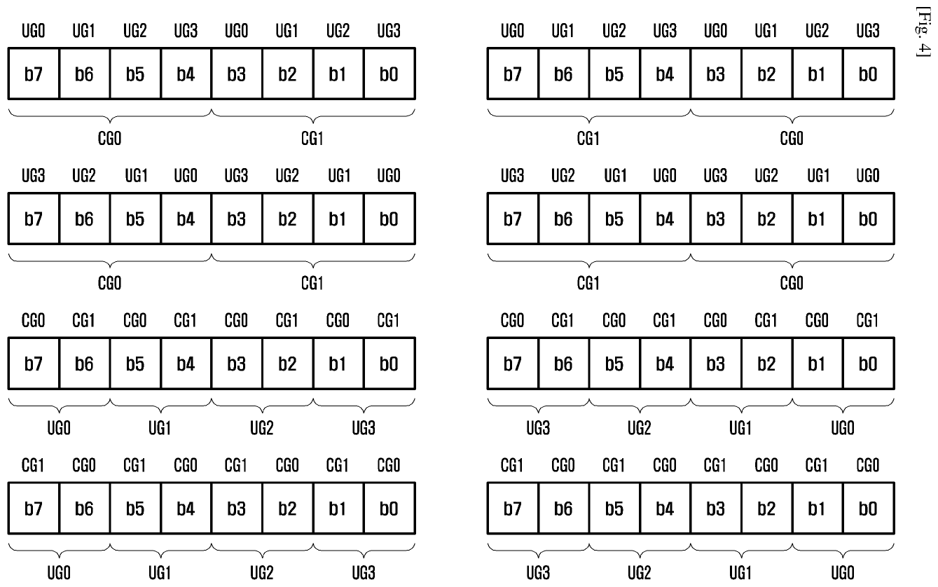

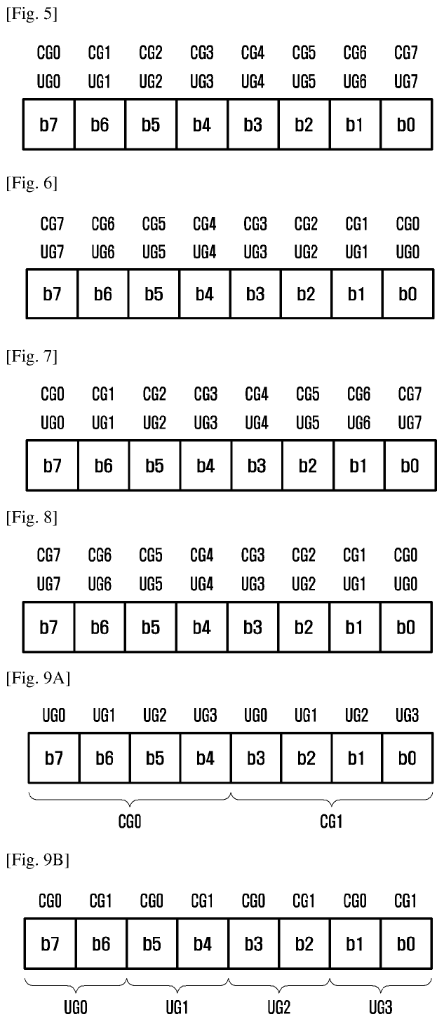

FIG. 5 illustrates an example of a bitmap corresponding to paging subgroups assigned by CN according to an embodiment of the disclosure.

Referring to FIG. 5, there are 8 paging sub groups and a bit map of size 8 is indicated by early paging indication. Each bit is mapped to distinct paging sub group. Paging subgroup IDs assigned by CN may be mapped to the bitmap from LSB (least significant bit) to MSB (most significant bit) in descending order from the highest paging subgroup ID.

If UEs subgroup assigned by CN is 2, UE checks b5.

FIG. 6 illustrates another example of a bitmap corresponding to paging subgroups assigned by CN according to an embodiment of the disclosure.

Referring to FIG. 6, there are 8 paging sub groups and a bit map of size 8 is indicated by early paging indication. Each bit is mapped to distinct paging sub group. Paging subgroup IDs assigned by CN may be mapped to the bitmap from LSB (least significant bit) to MSB (most significant bit) in ascending order from the lowest paging subgroup ID. If UEs subgroup assigned by CN is 2, UE checks b2.

In option 1-3, UE may use paging subgroup based on UE ID for monitoring early paging indication.

If the early paging indication includes a bitmap wherein each bit of the bitmap corresponds to a paging subgroup based on UE ID, UE checks for a bit in the bitmap corresponding to its paging subgroup based on UE ID.

FIG. 7 illustrates an example of a bitmap corresponding to paging subgroups based on UE ID according to an embodiment of the disclosure.

Referring to FIG. 7, there are 8 paging sub groups and a bit map of size 8 is indicated by early paging indication. Each bit is mapped to distinct paging sub group. Paging subgroup IDs determined by UE ID may be mapped to the bitmap from LSB (least significant bit) to MSB (most significant bit) in descending order from the highest paging subgroup ID. If UEs subgroup based on UE ID is 3, UE checks b4.

FIG. 8 illustrates another example of a bitmap corresponding to paging subgroups based on UE ID according to an embodiment of the disclosure.

Referring to FIG. 8, there are 8 paging sub groups and a bit map of size 8 is indicated by early paging indication. Each bit is mapped to distinct paging sub group. Paging subgroup IDs determined by UE ID may be mapped to the bitmap from LSB (least significant bit) to MSB (most significant bit) in ascending order from the lowest paging subgroup ID. If UEs subgroup based on UE ID is 3, UE checks b3.

Case 2: UE does not have paging subgroup assigned by CN

In option 2-1, UE may use both its paging subgroup assigned by CN and paging subgroup identified based on UE ID for monitoring early paging indication.

If the early paging indication includes a bitmap, wherein each bit of the bitmap corresponds to a paging sub group, UE checks for a bit in the bitmap corresponding to its paging subgroup assigned by CN and paging subgroup based on UE ID.

In an embodiment, If ‘X’ is the number of paging subgroups based on UE ID and if ‘Y’ is the number of paging sub groups assigned by CN, Y sets of bits where each set consists of ‘X’ bits can be there in early paging indication. Each set of ‘X’ bits is mapped to a distinct paging sub group assigned by CN. Each bit in the set is mapped to a distinct paging sub group based on UE ID. Each of these ‘Y’ sets of bits, can be a separate bitmap or it can be part of a bitmap.

FIG. 9A illustrates an example of a bitmap corresponding to paging subgroups according to an embodiment of the disclosure.

Referring to FIG. 9A, maximum number of CN paging sub groups is 2 (i.e. Y equals 2) and maximum number of UE ID based sub groups is 4 (i.e. X=4). There are two sets of 4 bits each, where each set is mapped to one of two CN paging sub groups (e.g., CG 0 and CG 1). Each bit in the set of 4 bits is mapped to one of four UE ID based Paging sub groups (e.g., UG0 to UG 3). If UE's subgroup based on UE ID is 3, UE checks b0 or b4 or both. If it is set to 1, UE monitors PO and receives the paging message scheduled by PDCCH received in monitored PO.

In another embodiment, If ‘X’ is the number of paging subgroups based on UE ID and if ‘Y’ is the number of paging sub groups assigned by CN, X sets of bits where each set consists of ‘Y’ bits can be there in early paging indication. Each set of ‘Y’ bits is mapped to a distinct paging sub group based on UE ID. Each bit in the set is mapped to a distinct paging sub group assigned by CN. Each of these ‘X’ sets of bits, can be a separate bitmap or it can be part of a bitmap.

FIG. 9B illustrates another example of a bitmap corresponding to paging subgroups according to an embodiment of the disclosure.

Referring to FIG. 9B, maximum number of CN paging sub groups is 2 (i.e. Y equals 2) and maximum number of UE ID based groups is 4 (i.e. X=4). There are four sets of 2 bits each where each set is mapped to one of four UE ID based paging sub groups (UG 0 to UG3). Each bit in the set of 2 bits is mapped to one of two CN assigned Paging sub groups (CGO to CG 1). If UE's subgroup based on UE ID is 3, UE checks b0 or b1 or both. If it is set to 1, UE monitors PO and receives the paging message scheduled by PDCCH received in monitored PO.

FIG. 4 illustrates examples of the various ways of mapping bits to CN assigned paging sub groups and UE ID based paging sub groups. FIG. 4 illustrates the case the maximum number of CN paging sub groups is 2 (i.e. Y equals 2) and maximum number of UE ID based groups is 4 (i.e. X=4). However, this can be applied for any values of X and Y.

In option 2-2, UE may use paging subgroup based on UE ID for monitoring early paging indication.

If the early paging indication includes a bitmap wherein each bit of the bitmap corresponds to a paging sub group based on UE ID, UE checks for a bit in the bitmap corresponding to its paging subgroup based on UE ID.

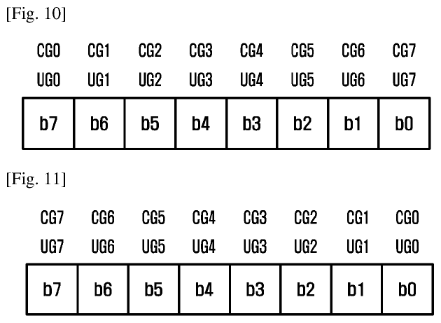

FIG. 10 illustrates an example of a bitmap corresponding to paging subgroups based on UE ID according to an embodiment of the disclosure.

Referring to FIG. 10, there are 8 paging sub groups and a bitmap of size 8 is indicated by early paging indication. Each bit of the bitmap is mapped to distinct paging sub group. Paging subgroup IDs determined by UE ID may be mapped to the bitmap from LSB (least significant bit) to MSB (most significant bit) in descending order from the highest paging subgroup ID. If UE's subgroup based on UE ID is 3, UE checks b4.

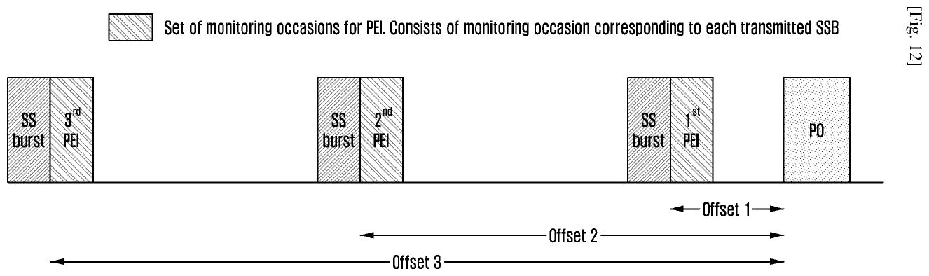

FIG. 11 illustrates another example of a bitmap corresponding to paging subgroups based on UE ID according to an embodiment of the disclosure.

Referring to FIG. 11, there are 8 paging sub groups and a bitmap of size 8 is indicated by early paging indication. Each bit of the bitmap is mapped to distinct paging sub group. Paging subgroup IDs determined by UE ID may be mapped to the bitmap from LSB (least significant bit) to MSB (most significant bit) in ascending order from the lowest paging subgroup ID. If UE's subgroup based on UE ID is 3, UE checks b3.

It is to be noted that in methods explained in the disclosure, paging subgroups assigned by CN may be referred as paging groups and paging subgroups assigned by UE ID may be refereed as paging sub groups. In an embodiment, paging sub groups may also be referred as paging.

In one method of the disclosure, it is proposed that a set of early paging indication may be transmitted by GNB multiple times at different offsets before the paging occasions. Each set consists of at least ‘S’ occasions for transmitting paging early indication (PEI) wherein each occasion is mapped to a SSB and ‘S’ is number of transmitted SSBs.

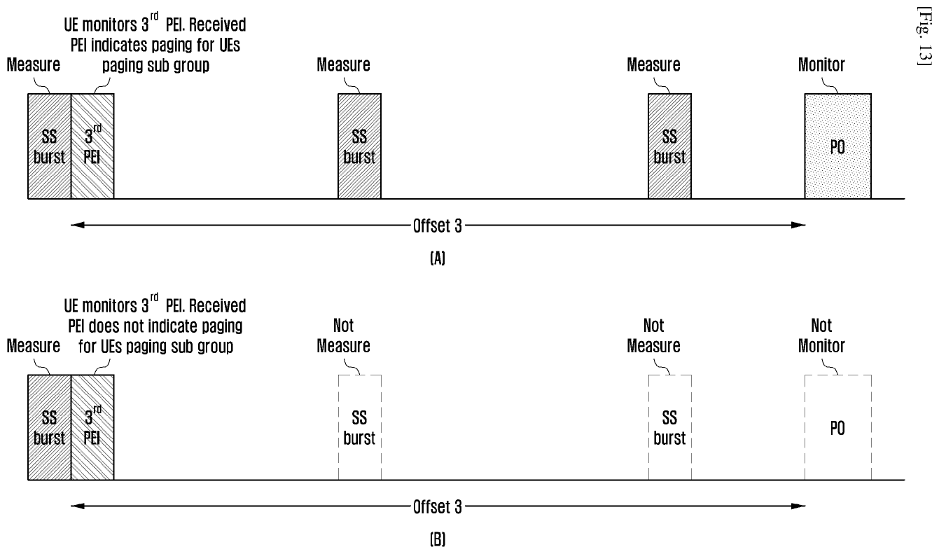

FIG. 12 illustrates an example of a plurality of PEI occasions with different offsets according to an embodiment of the disclosure.

Referring to FIG. 12, 1st, 2nd and 3rd set of PEI occasions are configured at offset 1, offset 2 and offset 3 with respect to start of PF/PO. In case there is paging i.e. PDCCH addressed to P-RNTI in PO schedules paging message, gNB transmits PEI in 1st, 2nd and 3rd set of PEI occasions. Note that information transmitted in each of these PEI is same. Set of PEI occasions may be FDMed with SS bursts.

Two DL RSRP thresholds (e.g., threshold 1 and threshold 2) are pre-defined or signaled by gNB in system information or RRC message. In an embodiment, only threshold 1 may be used. In an embodiment, in case that the number of set of PEI is N, N−1 thresholds are pre-defined or signaled by gNB in system information or RRC message. N is an integer.

FIG. 13 illustrates an example of an operation of a UE which is not in good channel condition according to an embodiment of the disclosure.

Referring to FIG. 13, if DL RSRP threshold is less than or equal to threshold 2 (i.e. UE is not in good channel condition), UE wakes up quite early and measures SS burst and monitors 3rd set of PEI. Referring to FIG. 13 (A), if received PEI indicates paging for UE's paging sub group, UE further measures additional SS bursts and monitor PDDCH addressed to P-RNTI in PO. UE then receives the paging message scheduled by received PDCCH in PO. Note that in between 3nd PEI and SS bursts and between SS burst and PO, UE can enter light sleep mode to save power. Referring to FIG. 13 (B), if received PEI does not indicate paging for UE's paging sub group, UE does not measure additional SS bursts and does not monitor PDDCH addressed to P-RNTI in PO and enters deep sleep state after monitoring PEI.

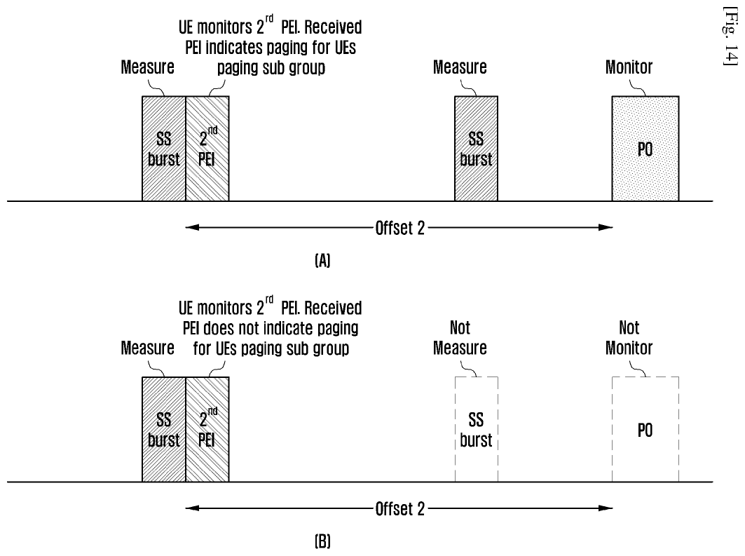

FIG. 14 illustrates an example of an operation of a UE which is in average channel condition according to an embodiment of the disclosure.

Referring to FIG. 14, if DL RSRP threshold is greater than threshold 2 but less than or equal to threshold 1 (i.e. UE is in average channel condition), UE wakes up early and measures a SS burst and monitor 2nd set of PEI. In an alternate embodiment, wherein only threshold 1 is used, If DL RSRP threshold is less than or equal to threshold 1 (i.e. UE is average channel condition), UE wakes up early and measures a SS burst and monitor 2nd set of PEI. Referring to FIG. 14 (A), if received PEI indicates paging for UE's paging sub group, UE further measures additional SS burst and monitors PDDCH addressed to P-RNTI in PO. UE then receives the paging message scheduled by received PDCCH in PO. Note that in between 2nd PEI and additional SS burst and between additional SS burst and PO, UE can enter light sleep mode to save power. Referring to FIG. 14 (B), if received PEI does not indicate paging for UE's paging sub group, UE does not measure additional SS burst and does not monitor PDDCH addressed to P-RNTI in PO and enters deep sleep state after monitoring PEI.

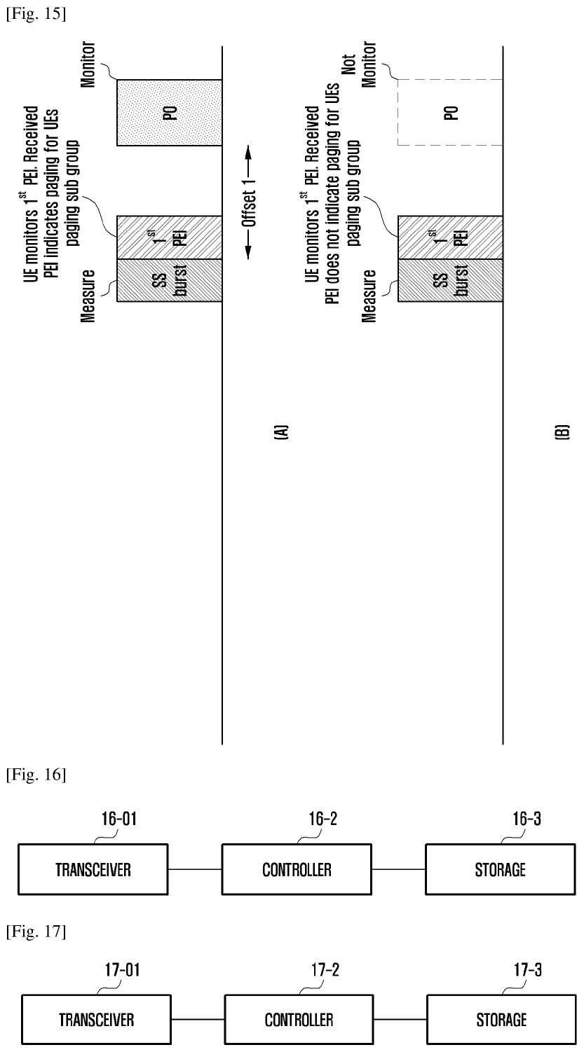

FIG. 15 illustrates an example of an operation of a UE which is in very good channel condition according to an embodiment of the disclosure.

Referring to FIG. 15, if DL RSRP threshold is greater than threshold 1 (i.e. UE is in very good channel condition), UE wakes up early and measures SS burst and monitor 1st set of PEI. Referring to FIG. 15 (A), if received PEI indicates paging for UE's paging sub group, UE monitor PDDCH addressed to P-RNTI in PO. UE then receives the paging message scheduled by received PDCCH in PO. Note that in between 1st PEI and PO UE can enter light sleep mode to save power. Referring to FIG. 15 (B), if received PEI does not indicate paging for UE's paging sub group, UE does not monitor PDDCH addressed to P-RNTI in PO and enters deep sleep state after monitoring PEI.

FIG. 16 illustrates an example of a structure of a UE according to an embodiment of the disclosure.

Referring to FIG. 16, the UE may include a transceiver 16-01, a controller 16-2, and a storage 16-3. However, the components of the UE are not limited to the above-described examples. For example, the UE may include more or fewer components than the aforementioned components. Further, the transceiver 16-01, the controller 16-2, and the storage 16-3 may be implemented in the form of a single chip. For example, the controller 16-2 may be defined as a circuit or application-specific integrated circuit or at least one processor.

The transceiver 16-01 may transmit and receive signals to and from another network entity. For example, the transceiver 16-01 may receive system information and RRC signaling being broadcasted from a base station according to an embodiment of the disclosure.

The controller 16-2 may be configured to control operations of the UE according to embodiments and/or methods of the disclosure. For example, the controller 16-2 may control signal flow between respective blocks so as to perform an operation according to the above-described drawings and flowcharts. Specifically, the controller 16-2 may be configured to receive, via the transceiver, system information, identify whether first information on a number of subgroups for UE identity (ID) based subgrouping is configured in the system information, and monitor a paging early indication. For example, in case that the first information is not configured, the paging early indication is monitored based on a subgroup ID assigned by a core network (CN). For example, the controller 16-2 may be configured to identify whether the UE is configured with the subgroup ID assigned by the CN, wherein in case that the UE is not configured with the subgroup ID assigned by the CN and the first information is configured in the system information, the paging early indication is monitored based on a subgroup ID determined by the UE ID based subgrouping. The controller 16-2 may be configured to receive, via the transceiver, configuration information on the paging early indication.

The storage 16-3 may store at least one of information being transmitted and received through the transceiver 16-01 and information being generated through the controller 16-2. In an embodiment, the storage comprises one or more memories.

FIG. 17 illustrates an example of a structure of a base station according to an embodiment of the disclosure.

Referring to FIG. 17, the base station may include a transceiver 17-01, a controller 17-2, and a storage 17-3. However, the components of the base station are not limited to the above-described examples. For example, the base station may include more or fewer components than the aforementioned components. Further, the transceiver 17-01, the controller 17-2, and the storage 17-3 may be implemented in the form of a single chip. For example, the controller 17-2 may be defined as a circuit or application-specific integrated circuit or at least one processor.

The transceiver 17-01 may transmit and receive signals to and from another network entity. For example, the transceiver 17-01 may transmit system information

The controller 17-2 may be configured to control operations of the base station according to embodiments and/or methods of the disclosure. For example, the controller 17-2 may control signal flow between respective blocks so as to perform an operation according to the above-described drawings and flowcharts. Specifically, the controller 17-2 may be configured to determine whether first information on a number of subgroups for UE identity (ID) based subgrouping is configured in system information, wherein in case that the first information is not configured, a paging early indication is monitored based on a subgroup ID assigned by a core network (CN). For example, the controller 17-2 may be configured to determine not to configure, to a user equipment (UE), the subgroup ID assigned by the CN. In case that the subgroup ID assigned by the CN is not configured to the UE and the first information is configured in the system information, the paging early indication is monitored based on a subgroup ID determined by the UE ID based subgrouping.

The storage 17-3 may store at least one of information being transmitted and received through the transceiver 17-01 and information being generated through the controller 17-2. In an embodiment, the storage comprises one or more memories.

In the above-described detailed embodiments of the disclosure, the elements included in the disclosure may be expressed in the singular or plural form depending on the proposed detailed embodiment. However, the singular or plural expression has been selected suitably for a situation proposed for convenience of description, and the disclosure is not limited to the singular or plural elements. Although an element has been expressed in the plural form, it may be configured in the singular form. Although an element has been expressed in the singular form, it may be configured in the plural form.

Meanwhile, although the detailed embodiments have been described in the detailed description of the disclosure, the disclosure may be modified in various ways without departing from the scope of the disclosure. Accordingly, the scope of the disclosure should not be limited to the above-described embodiments, but should be defined by not only the claims but also equivalents thereof.

1-15. (canceled)

16. A method performed by a user equipment (UE) in a wireless communication system, the method comprising:
receiving system information;
identifying whether the UE is configured with a subgroup identity (ID) assigned by a core network (CN);
identifying whether a cell supports a CN assigned subgrouping; and
monitoring a paging early indication on the cell,
wherein in case that the UE is configured with the subgroup ID assigned by the CN and the cell supports the CN assigned subgrouping, the paging early indication is monitored based on the subgroup ID assigned by the CN.

17. The method of claim 16, further comprising identifying whether first information on a number of subgroups for a UE ID based subgrouping is configured in the system information,
wherein in case that the UE is not configured with the subgroup ID assigned by the CN or the cell does not support the CN assigned subgrouping, the paging early indication is monitored based on another subgroup ID determined by the UE ID based subgrouping in case that the first information is configured in the system information.

18. The method of claim 16, wherein the system information includes configuration information on the paging early indication, and
wherein whether the cell supports the CN assigned subgrouping is identified based on the system information.

19. The method of claim 16, wherein the UE is in a radio resource control (RRC) idle state or an RRC inactive state.

20. The method of claim 16, wherein the paging early indication includes a plurality of bits, each bit corresponding to a subgroup of a paging occasion.

21. A method performed by a base station in a wireless communication system, the method comprising:
identifying whether a user equipment (UE) is configured with a subgroup identity (ID) assigned by a core network (CN);
determining whether a cell of the base station supports a CN assigned subgrouping;
transmitting system information; and
in case that the UE is configured with the subgroup ID assigned by the CN and the cell supports the CN assigned subgrouping, transmitting a paging early indication on the cell based on the subgroup ID assigned by the CN.

22. The method of claim 21, wherein the system information includes first information on a number of subgroups for a UE ID based subgrouping, and
wherein in case that the subgroup ID assigned by the CN is not configured to the UE or the cell does not support the CN assigned subgrouping, and in case that the first information is configured in the system information, the method further comprises transmitting the paging early indication based on another subgroup ID determined by the UE ID based subgrouping.

23. The method of claim 21, wherein the system information includes configuration information on the paging early indication, and
wherein the UE is in a radio resource control (RRC) idle state or an RRC inactive state.

24. The method of claim 21, wherein the paging early indication includes a plurality of bits, each bit corresponding to a subgroup of a paging occasion.

25. A user equipment (UE) in a wireless communication system, the UE comprising:
a transceiver configured to transmit and receive signals; and
a controller coupled with the transceiver and configured to:
receive, via the transceiver, system information,
identify whether the UE is configured with a subgroup identity (ID) assigned by a core network (CN),
identify whether a cell supports a CN assigned subgrouping, and
monitor a paging early indication on the cell,
wherein in case that the UE is configured with the subgroup ID assigned by the CN and the cell supports the CN assigned subgrouping, the paging early indication is monitored based on the subgroup ID assigned by the CN.

26. The UE of claim 25, wherein the controller is further configured to identify whether first information on a number of subgroups for a UE ID based subgrouping is configured in the system information, and
wherein in case that the UE is not configured with the subgroup ID assigned by the CN or the cell does not support the CN assigned subgrouping, the paging early indication is monitored based on another subgroup ID determined by the UE ID based subgrouping in case that the first information is configured in the system information.

27. The UE of claim 25, wherein the system information includes configuration information on the paging early indication,
wherein whether the cell supports the CN assigned subgrouping is identified based on the system information, and
wherein the UE is in a radio resource control (RRC) idle state or an RRC inactive state.

28. The UE of claim 25, wherein the paging early indication includes a plurality of bits, each bit corresponding to a subgroup of a paging occasion.

29. A base station in a wireless communication system, the base station comprising:
a transceiver configured to transmit and receive signals; and
a controller coupled with the transceiver and configured to:
identify whether a user equipment (UE) is configured with a subgroup identify (ID) assigned by a core network (CN),
determine whether a cell of the base station supports a CN assigned subgrouping,
transmit, via the transceiver, system information, and
in case that the UE is configured with the subgroup ID assigned by the CN and the cell supports the CN assigned subgrouping, transmit via the transceiver, a paging early indication on the cell based on the subgroup ID assigned by the CN.

30. The base station of claim 29, wherein the system information includes first information on a number of subgroups for a UE ID based subgrouping,
wherein in case that the subgroup ID assigned by the CN is not configured to the UE or the cell does not support the CN assigned subgrouping, and in case that the first information is configured in the system information, the controller is further configured to transmit the paging early indication based on another subgroup ID determined by the UE ID based subgrouping, and
wherein the UE is in a radio resource control (RRC) idle state or an RRC inactive state.
